(19) United States
(12) Patent Application Publication
(10) Pub. No.: US 2026/0299214 A1
(43) Pub. Date: Oct. 1, 2026

(54) VERY SMALL FORM FACTOR SHUTTERED FIBER-OPTIC ADAPTER

(71) Applicant: US Conec Ltd., Hickory, NC (US)

(72) Inventors: Scott Mendenhall, Hickory, NC (US); Jason Higley, Hickory, NC (US)

(21) Appl. No.: 19/139,725

(22) PCT Filed: Jan. 23, 2024
(86) PCT No.: PCT/US2024/012539

§ 371 Date: Jun. 16, 2025

Related U.S. Application Data
(60) Provisional application No. 63/481,109, filed on Jan. 23, 2023.

(51) Int. Cl. G02B 6/38

(52) U.S. Cl. CPC G02B 6/3825; G02B 6/3826; G02B 6/3849; G02B 6/3881; G02B 6/3885

(57) ABSTRACT

A fiber optic adapter for very small form factor (VSFF) fiber-optic connectors has a main body and has a main opening along a longitudinal axis between a first side and a second side of the main body and a shutter spring extending away from a central portion of the main body, the shutter spring formed by a plurality of extensions. The adapter also has a shutter support roof having a plurality of grips, the shutter support roof configured to receive the plurality of extensions of the shutter spring, and a plurality of shutters, each of the plurality of shutters being attached to at least another one of the plurality of shutters and also to the plurality of grips of the shutter support roof, each of the plurality of shutters engaging a respective one of the plurality of extensions of the shutter spring.

### CROSS-REFERENCE TO RELATED PATENT APPLICATION

This application claims priority to U.S. Provisional Patent Application Ser. No. 63/481,109 filed Jan. 23, 2023, the contents of all of which are incorporated by reference.

### BACKGROUND

Numerous fiber-optic adapter shutters have been used in the fiber-optic connector industry for dust and debris protection and/or to provide eye safety from an optical connection supported by the fiber-optic adapter (hereinafter “adapter”). These adapters typically also have an external adapter clip to secure the adapter to an adapter panel.

In recent years, very small form factor (VSFF) fiber-optic connectors (hereinafter “connectors” or “VSFF fiber-optic connectors”) have been introduced to support high density optical connection applications (for example, in data centers). One such connector is the MDC connector provided by the Applicant, and known to one of ordinary skill in the art, is disclosed in U.S. Pat. No. 11,016,250, incorporated by reference in its entirety herein.

Another example is the MMC connector, also known. These connector formats at least triple the conventional connection density as compared to that provided by LC type duplex connectors. Further, the newer connector formats are widely being accepted by the industry in view of the QSFP-DD multi-source agreements (MSAs).

Like older adapters, these newer high-density format connections require adapters with eye-safety and dust and debris protection. One challenge with such adapters is the small size and tight space in which the connectors are accommodated, leaving very little room for shutters to swing in internally upon insertion of one or more fiber-optic connector at any of the ports of the adapter. Further, due to the smaller dimensions of the space for each VSFF fiber-optic connector inside the adapter, these adapters require more precise guidance of the connectors as they enter the adapter and move towards the mating plane inside the adapter.

### SUMMARY OF THE INVENTION

The present invention is directed to a fiber optic adapter to accommodate at least two very small form factor (VSFF) connectors, the fiber optic adapter includes a main body formed by two long sides bound by two opposing short sides and having a main opening along a longitudinal axis between a first side and a second side of the main body, a shutter spring extending away from a central portion of the main body, the shutter spring formed by a plurality of extensions, a shutter support roof having a plurality of grips, the shutter support roof configured to receive the plurality of extensions of the shutter spring, and a plurality of shutters, each of the plurality of shutters being attached to at least another one of the plurality of shutters and also to the plurality of grips of the shutter support roof, each of the plurality of shutters engaging a respective one of the plurality of extensions of the shutter spring, wherein each of the plurality of shutters is rotatable between a closed position and an open position to receive one of the at least two VSFF fiber-optic connectors.

In some embodiments, the shutter spring is integral with an adapter clip, the adapter clip positioned at least partially around the main body.

In some embodiments, the plurality of extensions are attached to a central beam, the central beam disposed under the shutter support roof.

In some embodiments, the plurality of extensions comprise a first plurality of extensions and a second plurality of extensions, the first plurality of extensions disposed on a first side of the central beam and the second plurality of extensions disposed on a second side, the first plurality of extensions extending away from the central beam and the second plurality of extensions.

In other embodiments, each of the plurality of shutters have a first side wall and a second wall, the first side wall having a first plurality of elongated arcuate ribs (or ridges), the second side wall having a second plurality of elongated arcuate ribs (or ridges), the first plurality of ribs being offset from the second plurality of ribs along a length of the each of the plurality of shutters, such that the first plurality of elongated arcuate ribs on the first wall of one of the plurality of shutters fit between the second plurality of elongated arcuate ribs on the second wall of an adjacent one of the plurality of shutters.

In some embodiments, the first plurality of elongated arcuate ribs and the second plurality of elongated arcuate ribs block light from passing between the two adjacent shutters.

In some embodiments, at least some of the elongated arcuate ribs of each of the plurality of shutters move between the elongated arcuate ribs of an adjacent one of the plurality of shutters.

In some embodiments, the first side wall and the second side wall engage a corresponding structure on each side the VSFF fiber-optic connectors to guide the VSFF fiber-optic connectors into and from the fiber optic adapter.

In some embodiments, wherein the corresponding structure that engages the first side wall and the second side wall is a rail on each side of a housing of the at least two VSFF fiber-optic connectors.

In another aspect, the invention is directed to a fiber optic adapter to accommodate at least two very small form factor (VSFF) connectors (VSFF fiber-optic connectors), the fiber optic adapter includes a main body formed by two long sides bound by two opposing short sides and having a main opening along a longitudinal axis between a first side and a second side of the main body, an adapter clip positioned partially about the main body on an outside surface thereof, a shutter spring extending away from the adapter clip toward at least one of the first side and the second side, the shutter spring formed by one or more extensions having a respective free end, a shutter support roof engaged to only one of the two long sides and having one or more grips on an underside thereof, and one or more shutters attached to respective ones of the one or more grips of the shutter support roof, engages to a free end of the one or more extensions of the shutter spring, wherein the one or more shutters are rotatable between a closed position and an open position into the main body to receive one of the at least two VSFF fiber-optic connectors.

In yet another aspect, there is a shutter for blocking light from a fiber optic connector in an adapter that includes a first wall having a first plurality of elongated arcuate ribs on an outside surface thereof, a second wall having a second plurality of elongated arcuate ribs on an outside surface thereof, and a third wall extending between and separating the first wall and the second wall, wherein the first plurality of ribs are offset from the second plurality of ribs along a length of the shutter, such that the first plurality of elongated arcuate ribs on the first wall fit between a plurality of elongated arcuate ribs a wall of an adjacent shutter in the adapter.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a perspective view from the rear of one embodiment of a fiber optic adapter according to the present invention;

FIG. 2 is a perspective view from the front of the fiber optic adapter in FIG. 1;

FIG. 3 is a perspective view from the rear of the fiber optic adapter with a VSFF fiber-optic connector inserted into the fiber optic adapter of FIG. 1;

FIG. 4 is a rear elevation view of the fiber optic adapter in FIG. 1 with a VSFF fiber-optic connector inserted therein;

FIG. 5 is a perspective view from the upper left of the fiber optic adapter in FIG. 1 with the shutter support roof and the fiber optic connector removed;

FIG. 6 is a perspective view from the upper left of the fiber optic adapter in FIG. 1 with the adapter clip disengaged;

FIG. 7 is a partial perspective view of the fiber optic adapter in FIG. 1 showing the engagement of one of the shutter spring extensions with a shutter and the shutter support roof removed;

FIG. 8 is a perspective, view of the adapter clip in FIG. 5;

FIG. 9 is a left side elevation view of the adapter clip in FIG. 5;

FIG. 10 is a topside, perspective view of the fiber optic adapter in FIG. 1 showing the shutter support roof with the adapter clip removed;

FIG. 11 is an enlarged, perspective view of a portion of the fiber optic adapter in FIG. 1 with a VSFF fiber-optic connector inserted therein;

FIG. 12 is a bottom-side perspective view of a cross section of the fiber optic adapter in FIG. 1;

FIG. 13 is a perspective view of a bottom side of the shutter support roof;

FIG. 14 is a perspective view of a top side of the shutter support roof;

FIG. 15 is a perspective view of an outward facing side of one embodiment of a shutter according to the present invention;

FIG. 16 is a perspective view of an inward facing side of the shutter in FIG. 15;

FIG. 17 is a perspective view of two shutters being attached to one another;

FIG. 18 is a perspective view of the two shutters of FIG. 17 attached to one another;

FIG. 19 is an elevation view of three shutters attached to one another;

FIG. 20 is a cross section view of the fiber optic adapter of FIG. 1 with a VSFF fiber-optic connector ready to be inserted;

FIG. 21 is a cross section view of the fiber optic adapter of FIG. 1 with the VSFF fiber-optic connector engaging the shutter;

FIG. 22 is a cross section view of the fiber optic adapter of FIG. 1 with a VSFF fiber-optic connector inserted farther into the fiber optic adapter;

FIG. 23 is a cross section view of the fiber optic adapter of FIG. 1 with a VSFF fiber-optic connector fully inserted;

FIG. 24 is a cross section view of a portion of the fiber optic adapter of FIG. 1 showing the engagement of the shutter spring extensions with the shutters;

FIG. 25 is a perspective view of the rear of the fiber optic adapter in FIG. 1 with the shutter support roof disengaged;

FIG. 26 is a perspective view from under the adapter clip showing the engagement of the shutters, the shutter support roof, and the shutter spring extensions;

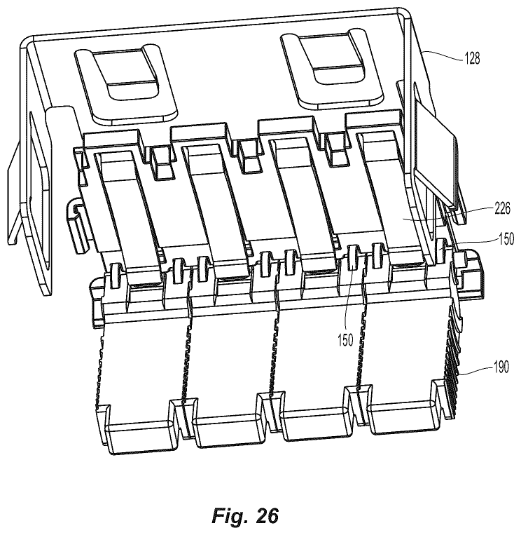

FIG. 27 is a perspective view of the VSFF fiber-optic connector engaging the shutters, the shutters guiding the VSFF fiber-optic connector into the fiber optic adapter in FIG. 1;

FIG. 28 is a side elevation view of the VSFF fiber-optic connector fully inserted into the fiber optic adapter of FIG. 1;

FIG. 29 is a top view of the VSFF fiber-optic connector and fiber optic adapter in FIG. 28;

FIG. 30 is a detailed view of the latching mechanism of the VSFF fiber-optic connector engaging the fiber optic adapter in FIG. 1;

FIG. 31 is a detailed view of the latching mechanism of the VSFF fiber-optic connector engaging the latching posts of fiber optic adapter in FIG. 1 with other structures removed for a clearer view;

FIG. 32 is a perspective view of another embodiment of a fiber optic adapter according to the present invention;

FIG. 33 is a perspective view of yet another embodiment of a fiber optic adapter according to the present invention;

FIG. 34 is a cross section view of a portion of the fiber optic adapter of FIG. 33 showing the engagement of the shutter spring extensions with the shutters; and

FIG. 35 is a perspective view of the fiber optic adapter of FIG. 33 with the shutter support roof and adapter clip in place.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

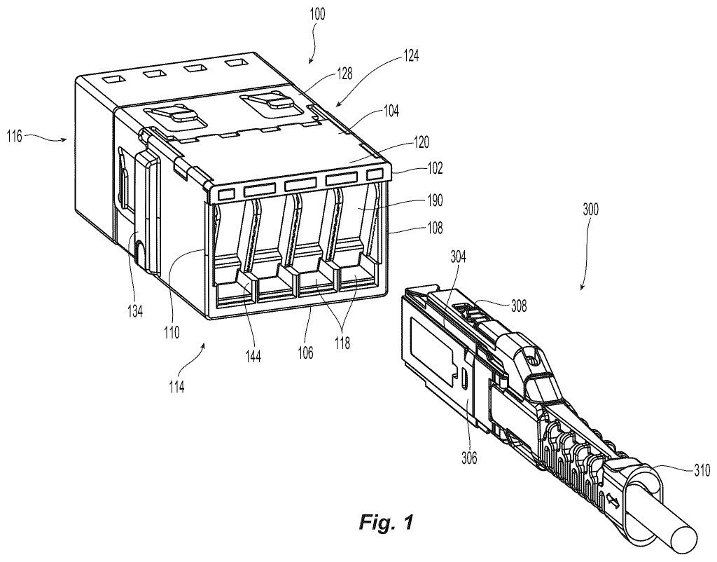

Applicant notes that the term “front” or “forward” means that direction where the fiber optic connector would meet with another fiber optic connector or device, while the term “rear” or “rearward” is used to mean the direction from which the optical fibers enter into the fiber-optic ferrule or fiber optic connector. Each of the components will therefore have a front and rear, and the two respective fronts or forward portions of opposing ferrules would engage one another. Thus, in FIG. 1, the “front” of the fiber optic adapter is on the left side and “forward” is to the left and into the page. “Rearward” or “rear” is that part of the fiber optic adapter that is on the right side of the page and “rearward” and “backward” is toward the right and out of the page.

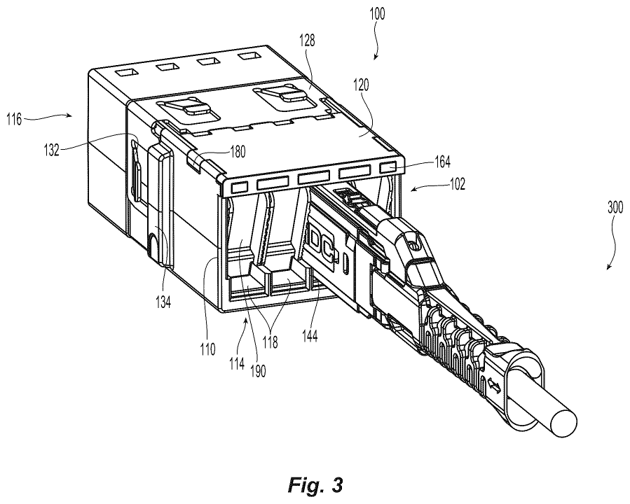

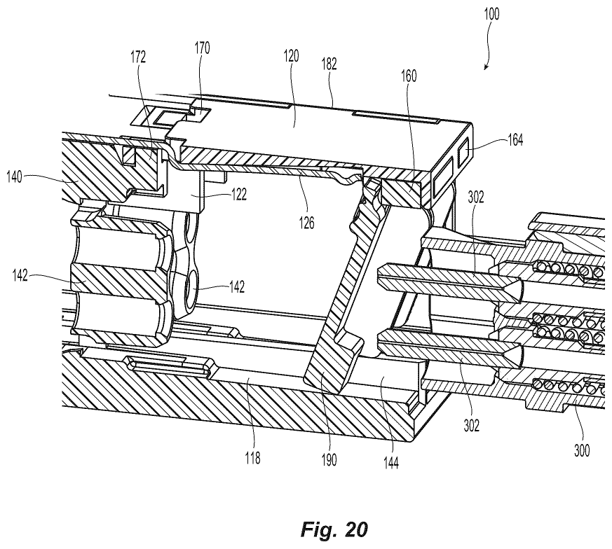

Illustrated in FIGS. 1-4 is a fiber optic adapter 100 to accommodate at least two very small form factor (VSFF) connectors (VSFF fiber-optic connectors) 300. As is known in the art, the VSFF fiber-optic connector 300 has two single-fiber ferrules 302. See FIGS. 20-23. However, the present invention can also accommodate a VSFF fiber-optic connector 300 with a single, multi-fiber ferrule, such as the MMC ferrule available from the Applicant.

The fiber optic adapter 100 has a main body 102 formed by two long sides 104,106 (top and bottom walls) that are bound by two opposing short sides 108,110 (first and second side walls). The main body 102 has a main opening 112 along a longitudinal axis A between a first side 114 and a second side 116 of the main body 102. The main opening 112 accepts the VSFF fiber-optic connectors 300 on either or both sides of the main body 102 and from either the first side 114 or the second side 116. In this embodiment, up to four different VSFF fiber-optic connectors 300 could be accepted into each side of the main body 102 in spaces or ports 118. At least two such ports are typically present, although the fiber optic adapter 100 could also be a single port adapter. A four-port adapter is shown in the figures herein. The ports 118 may be referred to as channels 118, too.

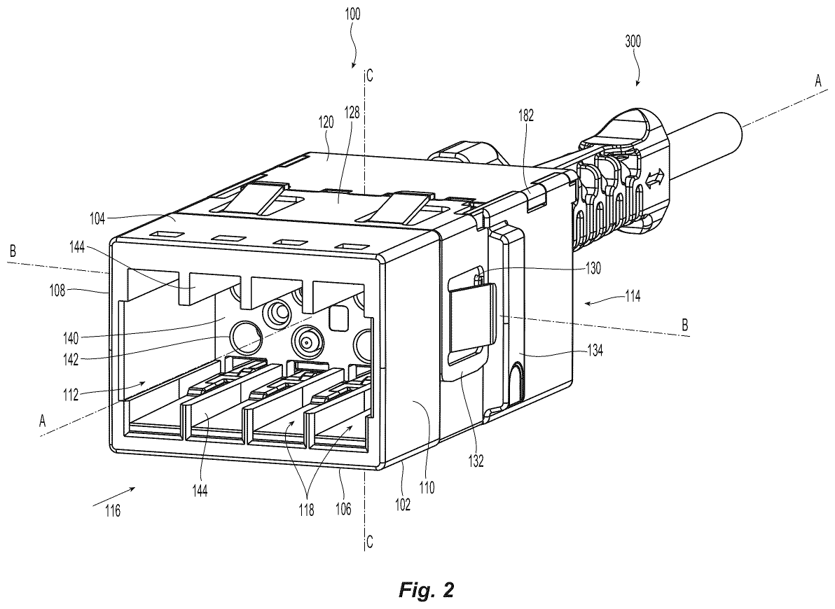

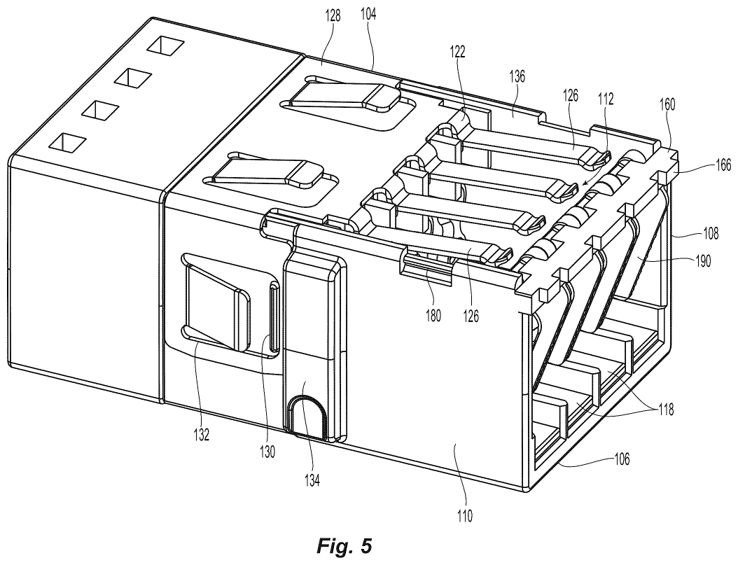

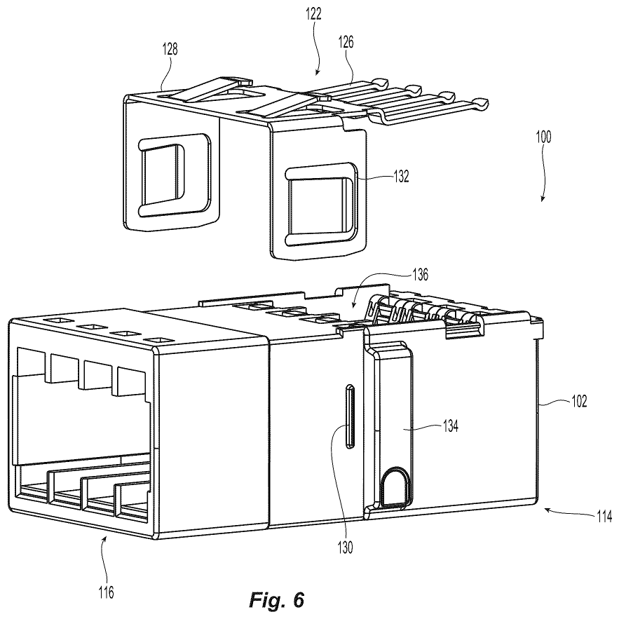

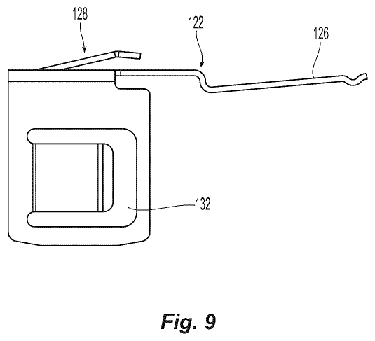

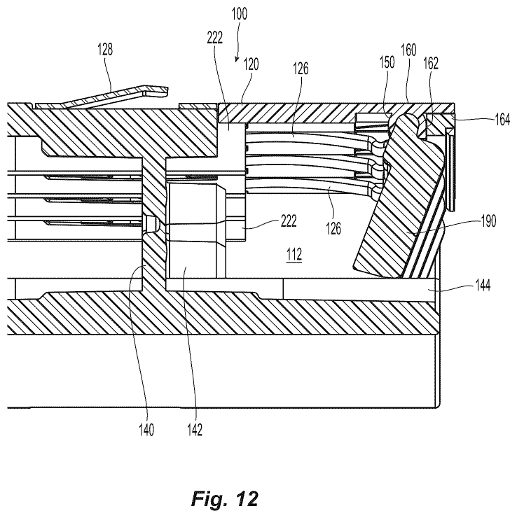

A shutter support roof 120 is provided on only one side of the main body, for example, on a top wall 104 (but may alternatively be provided only on a bottom wall 106 instead). Referring to FIGS. 5, 6, and 8, under the shutter support roof 120 is a shutter spring 122 extending away from a central portion 124 of the main body 102, the shutter spring 122 is formed by a plurality of extensions 126. Specifically, in FIG. 9, the extensions 126 (shown in a side elevation view) is at a slight angle to the longitudinal axis A (of FIG. 2) and to the rest of the adapter clip 128 when the adapter clip 128 is installed and the shutters 190 are in a closed position (i.e., without the VSFF fiber-optic connector 300 inside the main body 102). This angle aids the extensions 126 to be inserted into respective spring windows 170 in the shutter support roof 120. As a result, the extensions 126 sit underneath the shutter support roof 120 (and underneath tapered surfaces 186) and engage an inside facing surface 194 of the respective shutters 190. See, e.g., the cross-section shown in FIG. 12.

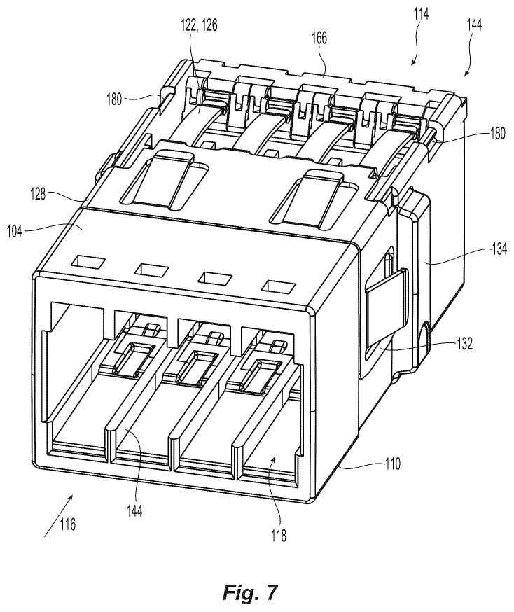

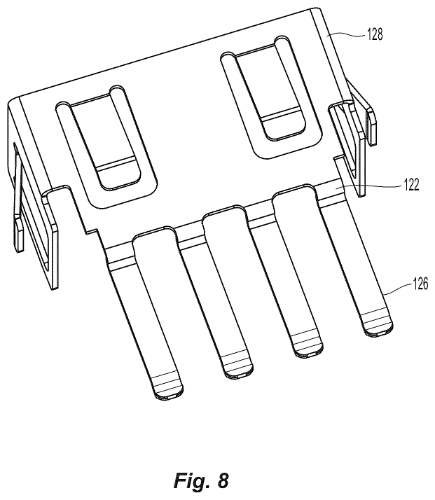

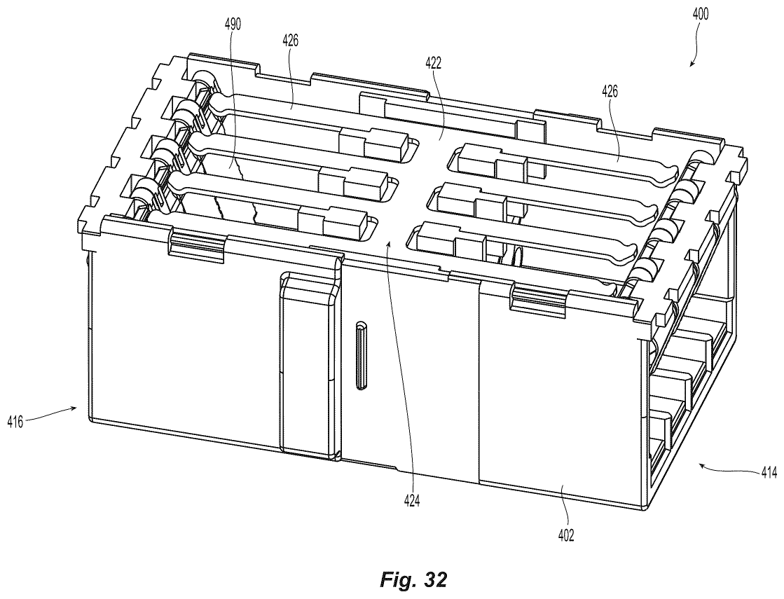

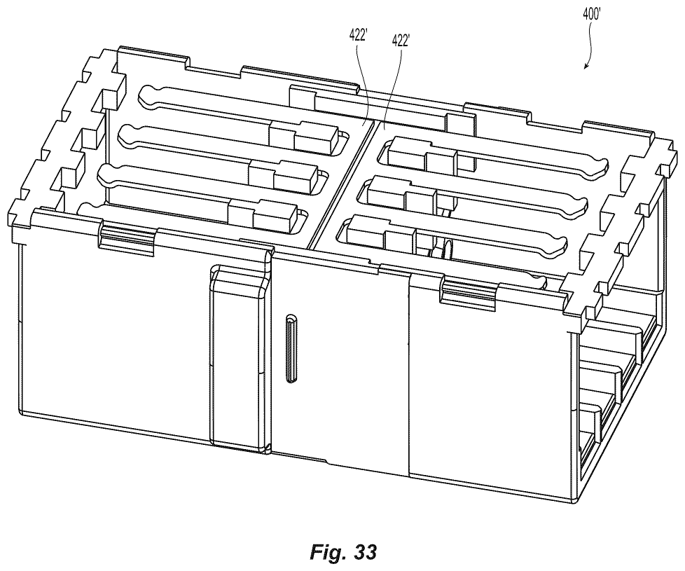

As illustrated, the plurality of extensions 126 are directed toward the first side 114, and as discussed below, bias the shutters 190 in a closed position. See, e.g., FIG. 7. The shutter spring 122 may be integral with an adapter clip 128 (as also visible in FIG. 8), the adapter clip 128 positioned at least partially around the main body 102. As discussed below, the shutter spring 122 and the plurality of extensions 126 may be separate from the adapter clip 128. It is also possible that there is a shutter spring that is directed to each of the first side 114 and the second side 116. See, e.g., FIGS. 32 and 33. The main body 102 may also have a projection 130, on one or both sides 108,110 of the main body 102, that engages an opening 132 in the adapter clip 128. See also FIG. 9. The adapter clip 128, in conjunction with a flange 134, keeps the fiber optic adapter 100 within a panel or other receptacle as is known in the art. The shutter support roof 120 also covers an opening 136 in the main body 102 and is in communication with the main opening 112. See FIGS. 5 and 7. In one aspect, the first side 114 of the main body may be different from the second side 116. For example, the second side may not have any shutters 190 and may be of a different size or geometry. A yet another example, the second side 116 may be shaped to receive individual single fiber connectors or bare multi-fiber ferrules (when the first side has an MMC connector, for example). The second side 116 may be present within a cassette instead of on an opposite side of an adapter panel (which is typically where the adapter shown herein would be used).

As seen in FIG. 2, there is a central wall 140 to that is present between the first side 114 and the second side 116. The central wall 140 may also have ferrule mating features.

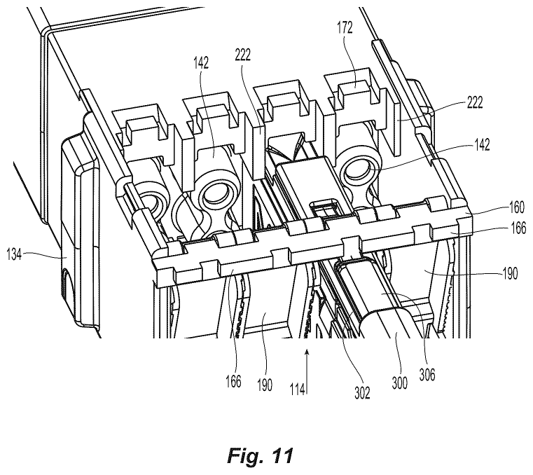

For example, when VSFF fiber-optic connectors 300 are mated, the central wall 140 includes sleeves 142 to secure two single-fiber ferrules 302 in the mated positions. See also FIGS. 11 and 20-23. A different type of a wall may be provided with openings to accommodate a different ferrule. Alternatively, there may be no central wall inside the main body of the fiber optic adapter 100, as is the case with the adapter for the MMC connector having the TMT ferrule, or other types of multi-fiber ferrules.

Other than the central wall 140, the main body 102 is free of solid walls between the side walls 108,110 and between the top and the bottom walls 104,106. Thus the ports 118 are in communication with each other without any walls being present along a lateral axis B. Likewise, the central wall 140 is the only wall present within the main body 102 along a transverse axis C, as well as the lateral axis B, and moving toward the first side 114 and the second side 116 away from the central wall, the fiber optic adapter 100 is free of any walls.

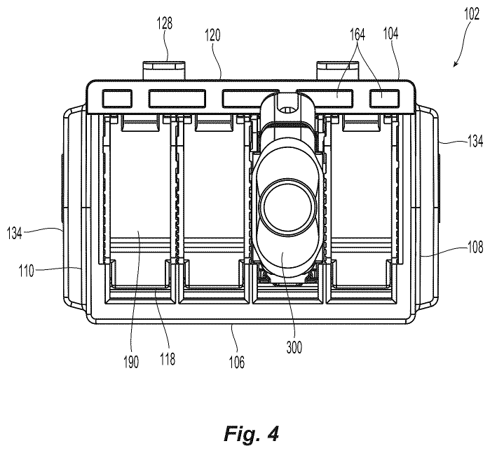

Only partial partition walls or ridges 144 are formed inside the main body 102 and extend from the top and the bottom walls 104,106 toward and into the main opening 112 as guidance features for the individual housings of the VSFF fiber-optic connectors 300. The partition walls 144 also provide a surface for the shutters 190 to rest on when a port 118 of the fiber optic adapter 100 is not populated, as shown, for example in FIG. 4. Since the partition wall 144 is partial, the shutters 190 have more space to align the VSFF fiber-optic connectors 300. See also FIGS. 4 and 18-19. However, there could be full walls between two ports 118 along the direction of the lateral axis B if the shutters 190 and/or the partial wall 144 were to be made thinner or made of a metallic material, for example. See FIG. 2.

Further, higher port counts, for example five or more ports (or, six ports 118) may require a partition wall (not shown) separating three ports from the remaining three ports. Likewise, an eight-port adapter may have four ports 118 on one side of such a partition wall and an additional four ports 118 on the other side. Such a partition wall may be for stiffening purposes and would be perpendicular to the central wall 140.

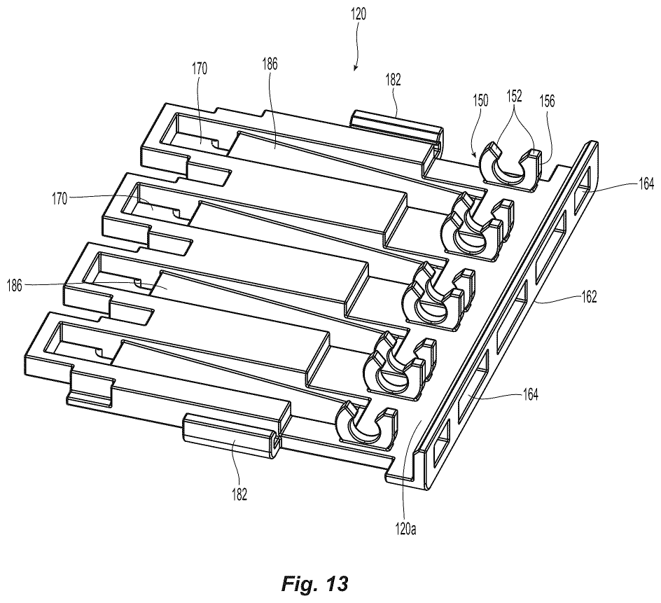

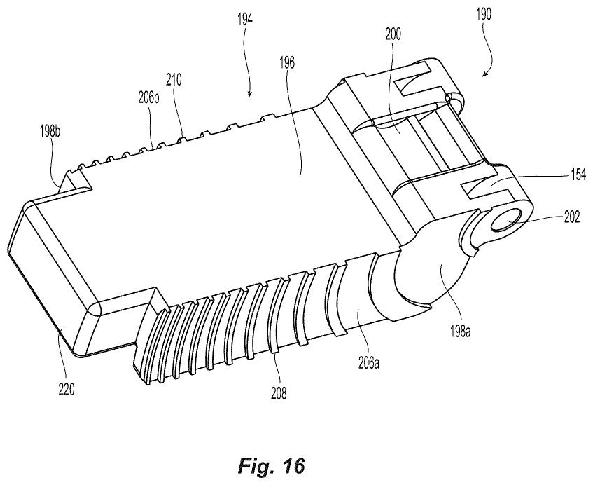

The fiber optic adapter 100 has the shutter support roof 120 that covers the opening 136 in the main body 102. FIG. 13, for example, shows that the shutter support roof 120 has a plurality of grips 150 that extend away from an inner surface 120a to engage the shutters 190. The shutter support roof 120 is configured to receive the plurality of extensions 126 of the shutter spring 122. Each of the plurality of grips 150 has two arms 152 that have surfaces that match the curved geometry (generally like a C-shape) of a rounded portion formed between a hole 202 and a cylindrical beam 204 on each shutter 190. See, e.g., FIG. 12. When attached, the arms 152 go into grip holes 154 on the shutter 190, as shown in FIG. 16. Thus, each shutter 190 is held by two grips 150—one for each side of the shutter 190.

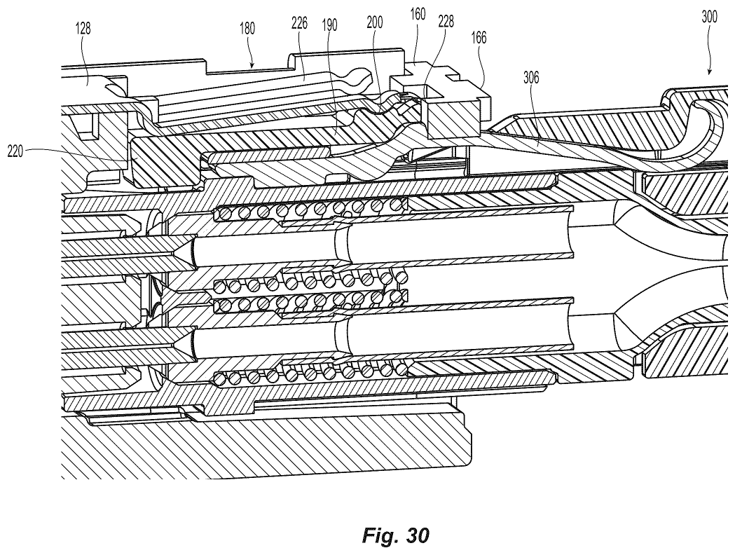

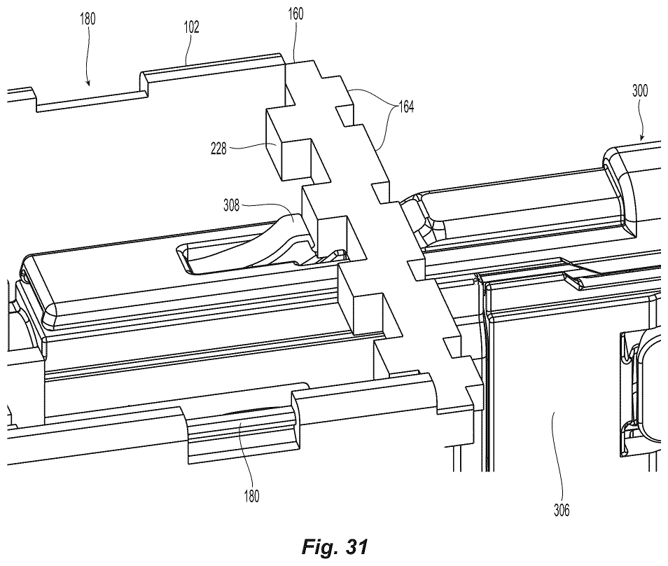

One of the arms 152 of each grip 150 has a flat outward surface 156 facing away from the inner portions of the main opening 112. This flat outward surface 156 engages a latch wall 160 of the main body of the adapter. See, e.g., FIGS. 11, 12. This engagement with the latch wall 160 and the flat outward surface 156 of the grip 150 resists forces that may otherwise cause the shutter 190 to rotate outward toward the first end 114, and be removed from between the grips 150, which would be undesirable. The grips 150 are offset along the longitudinal axis A (shown in FIG. 4) from an edge 162 of the shutter support roof 120. The edge 162 has detent openings 164 to accommodate detents or projections 166 on the latch wall 160. See also FIGS. 5, 7 and 12 for the latch wall 160. The latch wall 160 engages a latch 308 on the VSFF fiber-optic connectors 300, as also discussed with respect to FIGS. 30 and 31.

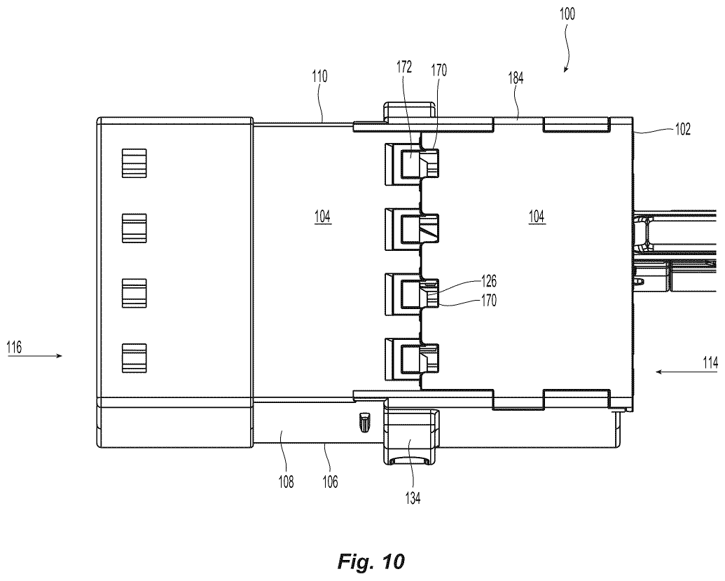

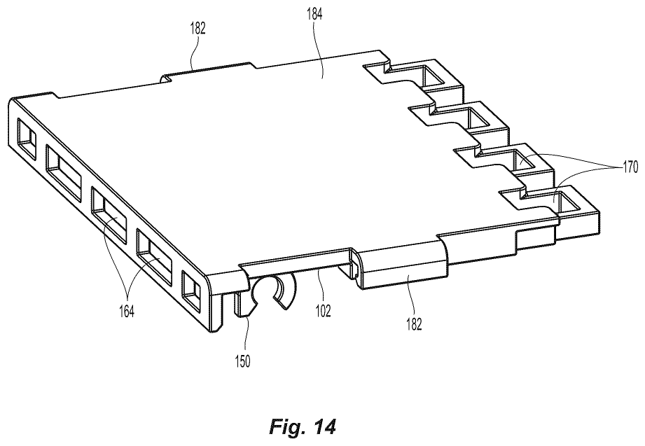

Turning to FIGS. 10, 11, 13, and 14, there are other additional structures that assist in holding the shutter support roof 120 on the main body 102. First there are spring windows 170 in the shutter support roof 120 that engage corresponding posts 172 in the main body 102—behind the opening 136 along the longitudinal axis A. The spring windows 170 also provide access to the opening 136 and the shutters 190 for the shutter spring 122 and the plurality of extensions 126. With the spring windows 170 being closer to the first end 114, the extensions 126 function to hold the shutter support roof 120 on the posts 172. There may also be a cutout 180 on the main body 102 (see, FIG. 2) with a bar disposed therein on the main body 102 along the side and then there is a corresponding tab 182 on the shutter support roof 120 that engages the cutout 180. See FIG. 5. Other types of connections could be used along the side of the main body 102 or they could be omitted entirely. The top surface 184 of the shutter support roof 120 is preferably flat. See FIG. 14.

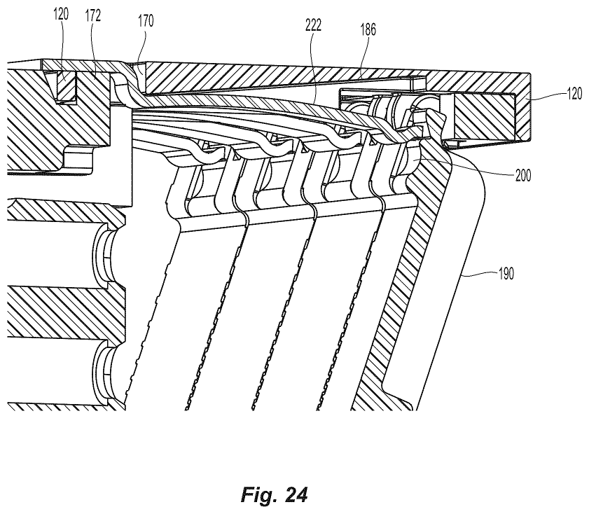

The inner surface 120a of shutter support roof 120 may also have a numbered of elongated, tapered surfaces 186 that coincide with the plurality of extensions 126. See FIGS. 13, 20-24. They are also between sets of grips 150 since the plurality of extensions 126 are to engage the shutters 190. As described in more detail below, as the shutters 190 rotate inward into the main opening 112 toward the central wall 140, the plurality of extensions 126 are moved upward and into the elongated, tapered surfaces 186.

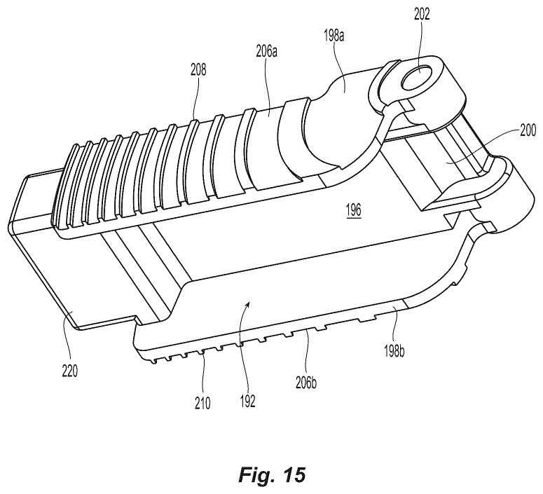

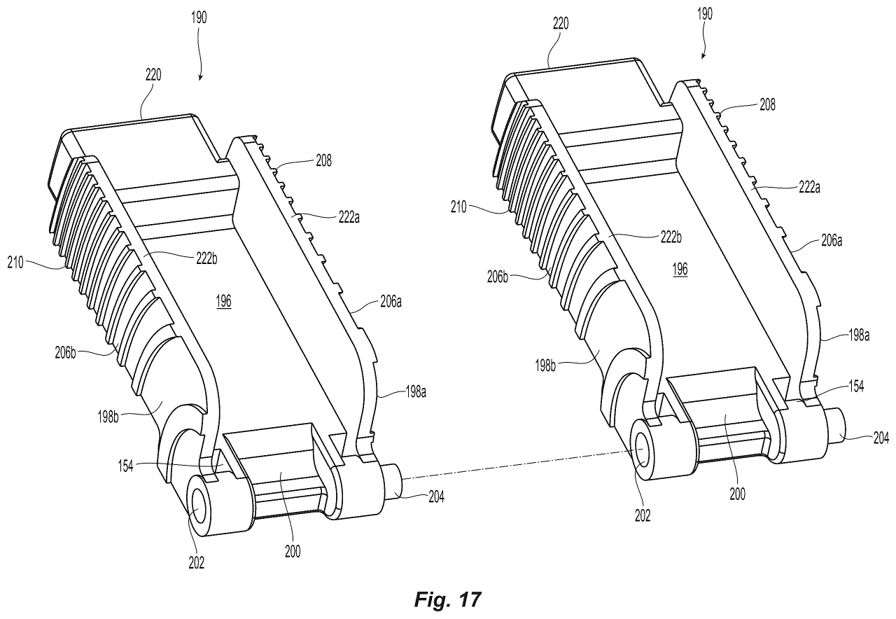

Next, the fiber optic adapter 100 has a plurality of shutters 190, one for each of the ports 118. Each of the plurality of shutters 190 has an outside facing side 192 (facing the first side 114) and the inside facing surface 194 (facing the second side 116). See FIGS. 15 and 16, respectively. Each of the plurality of shutters 190 has a base wall 196 and two side walls 198a, 198b. The two side walls 198a, 198b are separated such that they engage structures on the VSFF fiber-optic connectors 300 as discussed below. The inside facing side 194 of the shutters 190 is preferably smooth. At the top of the shutters 190 are structures that assist in the function of the shutters 190. As noted above, there are grip holes 154 on the shutter 190 for the grips 150. See FIG. 16. This allows for the shutters 190 to rotate relative to the main body 102. There is also a pocket 200 that accept the ends of the extensions 126. Also there is a hole 202 on one side of the shutters 190 and the cylindrical beam 204 on the other side. That is, the first side wall 198a of the shutter 190 has the hole 202 and the second side wall 198b has the cylindrical beam 204. See FIG. 17. The beam 204 fits within the hole 202 of another adjacent shutter 190. In the fiber optic adapter 100 above, there are four such shutters 190, each attached at least one adjacent shutter 190.

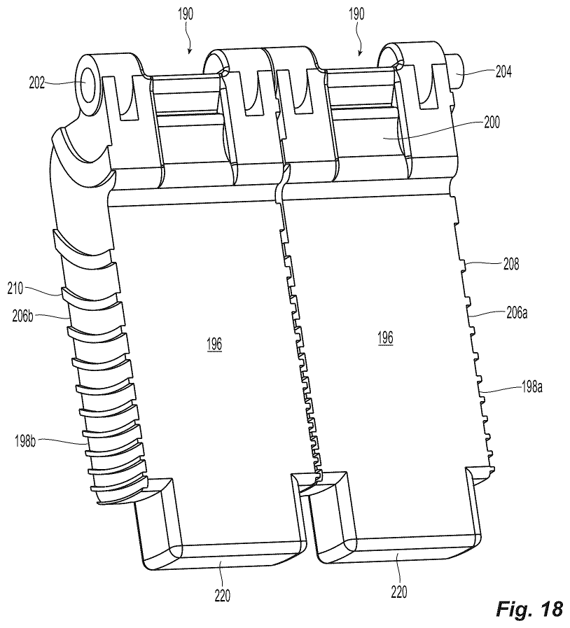

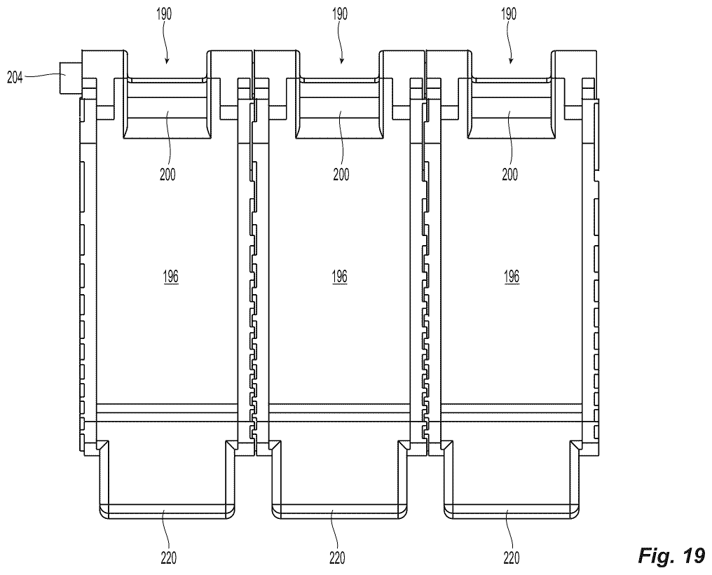

Preferably, the outside surfaces 206a, 206b of the two side walls 198a,198b have elongated arcuate ribs (or ridges) 208,210. The elongated arcuate ribs 208 are positioned relative the elongated ribs 210 so that they are intermeshed with each other. That is, each of the elongated arcuate ribs 208 on a first shutter 190 are positioned between the elongated arcuate ribs 210 on a second shutter. The elongated arcuate ribs 208,210 are curved so that two adjacent shutters 190 can rotate and move independently from one another without any mutual obstruction. See, e.g., FIG. 18. That naturally means that each of the arcuate ribs 208, 210 would have a different arc-more curved toward the top of FIG. 18 and less curved toward the bottom along a top to bottom length of the shutter 190. The elongated arcuate ribs 208,210 are also such that when two adjacent shutters 190 are closed (next to one another), no light can pass between the two shutters 190. See FIG. 19 that shows a view of the shutters 190 from inside the main body 102. For the shutters 190 that are at the end (or for a single port adapter), the internal side walls of the main body 102 can also have the elongated arcuate ribs 208,210.

At the opposite end of the shutters 190 is a free end 220. The free end 220 is the part of the shutter 190 that touches the bottom of the ports 118 to seal off the ports 118. See FIGS. 1, 3, and 12, for example. The free end 220 also fits between the partition walls or ridges 144 at the bottom of the main opening 112. See FIG. 4. When the shutter 190 is open and the VSFF fiber-optic connectors 300 are fully inserted, there are ribs 222 adjacent to the posts 172 in the main body 102—behind the opening 136—that the free ends 220 fit between. FIGS. 11, 12, 20, 21, 27, and 28. This configuration provides more stability for the shutters 190, which in turn provides more stability for the VSFF fiber-optic connectors 300. Further in this regard is that the two side walls 198a,198b have outward facing surfaces 222a,222b, respectively, that function as alignment surfaces and guide the VSFF fiber-optic connectors 300 into the fiber optic adapter 100 as discussed in more detail below.

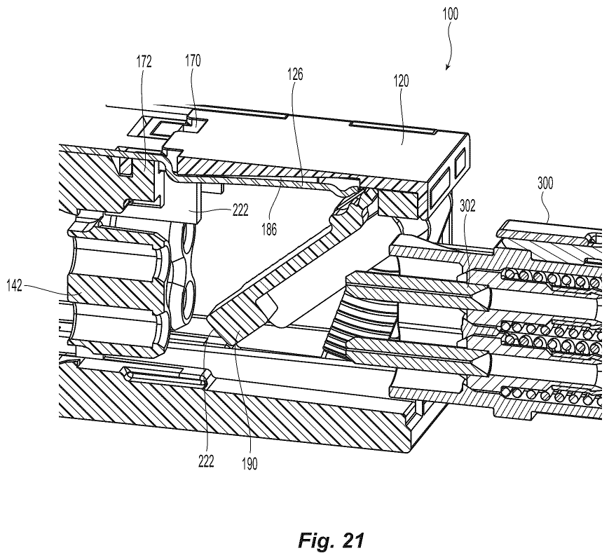

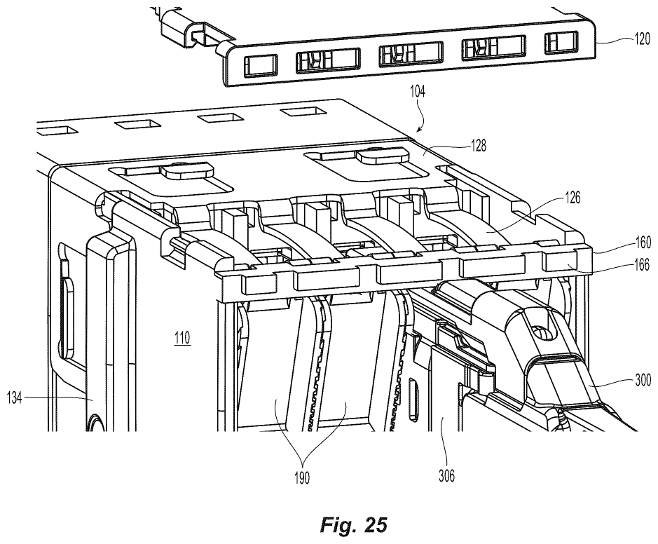

Turning back to FIGS. 20-25, the VSFF fiber-optic connectors 300 is being inserted into the fiber optic adapter 100, with a housing 306 of the fiber optic connector 300 engaging the shutter 190 first, in particular the outward facing surfaces 222a,222b. As seen in FIG. 20, the ferrules 302 are between the two side walls 198a, 198b as the VSFF fiber-optic connectors 300 is inserted. The shutter 190 is rotating about the axis of the hole 202 and beam 204. The free end 220 is moved away from the inside bottom surface of the port 118 and the extensions 126 are rotated up towards the shutter support roof 120 and towards the elongated, tapered surfaces 186. FIG. 21 has the VSFF fiber-optic connector 300 inserted farther into the fiber optic adapter 100 and having the outward facing surfaces 222a,222b engaging a rail 304 (see, e.g., FIG. 1) on the housing 306 of the VSFF fiber-optic connectors 300. That is, the shutter 190 does not touch the ferrule 302. Instead, the housing 306 contacts the shutter 190 first pushing the shutter 190 towards the shutter support roof 120. Likewise, if the VSFF fiber-optic connectors 300 are multi-fiber connectors (male or female), e.g., MMC connectors, an end face of the female multi-fiber ferrule (not shown) or in the case of a male ferrule (not shown), the guide pins don't collide with the shutter 190.

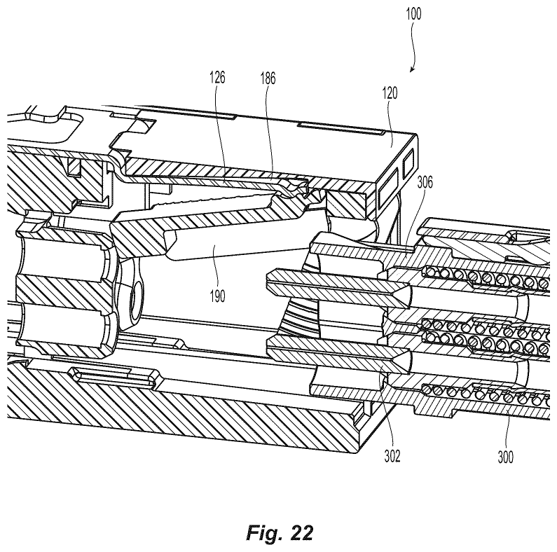

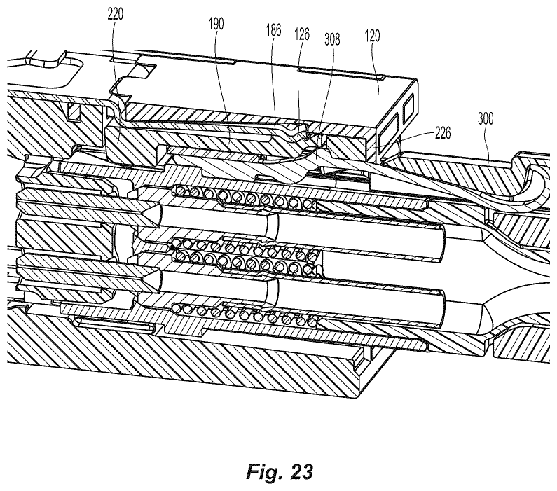

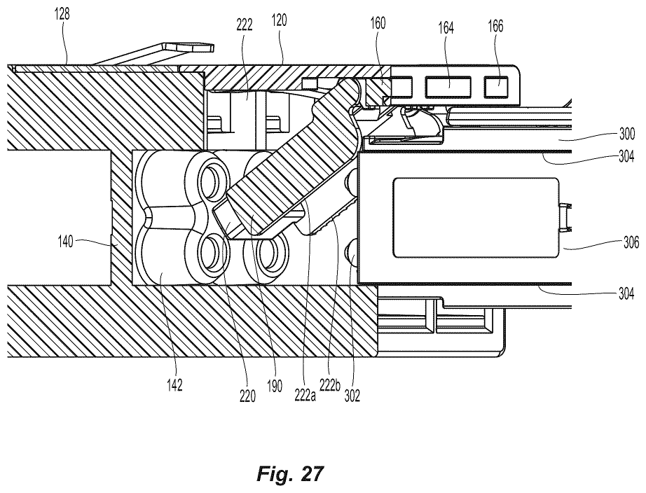

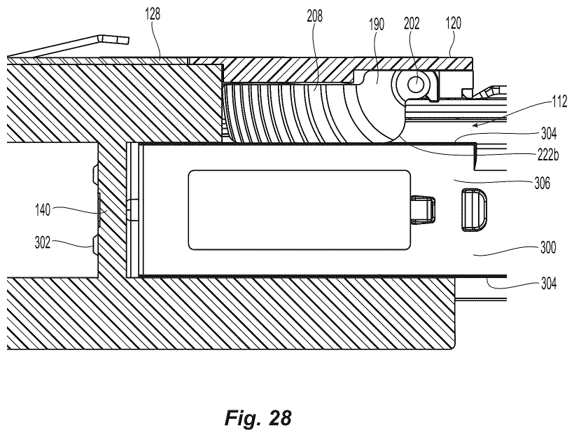

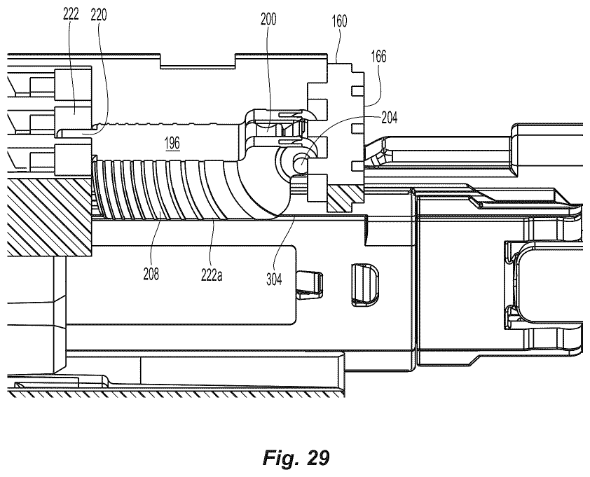

At the same time, the rail 306 on the bottom of the VSFF fiber-optic connector 300 engages the partial partition walls or ridges 144 to assist in guiding the VSFF fiber-optic connector 300 into the fiber optic adapter 100. FIG. 22 has the VSFF fiber-optic connector 300 still further into the fiber optic adapter 100 and the free end 220 about to be disposed between the ribs 222. See also FIG. 27, which is from a slightly different angle. FIG. 23 shows the VSFF fiber-optic connector 300 fully inserted into the fiber optic adapter 100. See also FIGS. 28 and 29, showing the VSFF fiber-optic connector 300 fully inserted and the shutter 190 out of the way.

FIGS. 30 and 31 illustrate how the VSFF fiber-optic connector 300 is retained within the fiber optic adapter 100. As the VSFF fiber-optic connector 300 is inserted into the port 118 of the fiber optic adapter 100, the latch 308 engages the latch wall 160. The latch 308 is pliable and is able to be inserted into the port 118, and under the latch wall 160. There is a latch post 226 on the back side of the latch wall 160 and facing toward the second side 116 of the main body 102 to engage the latch 308 and keep the VSFF fiber-optic connector 300 in the fiber optic adapter 100. As is known with the VSFF fiber-optic connector 300, the connector can be removed by pulling on the boot 310. That causes the latch 308 to flatten out and pass under the latch post 226 and the latch wall 160. As the VSFF fiber-optic connector 300 is removed, the shutters 190 rotate back into their closed position due to the extensions 126 sliding downward within the pocket 200, sealing off the main opening 112.

To assemble the fiber optic adapter 100, and the shutter support roof 120 and the shutters 190, first the shutters 190 are assembled together, as shown in FIG. 17. This process is repeated for as many shutters 190 as there are ports 118. Once the shutters 190 are assembled together, they are attached to the shutter support roof 120 with the grips 150. The shutter support roof 120 and the shutters 190 are then attached to the main body 102. The adapter clip 128 is then attached such that the extensions 126 are inserted into the respective spring windows 170 before the side extensions of the adapter clip 128 are snapped in place. Alternatively, the adapter clip 128 may be preinstalled, and the extensions 126 wiggled in through the spring windows 170 as the assembly of shutter support roof 120 with the shutters 190 is installed onto the main body 102.

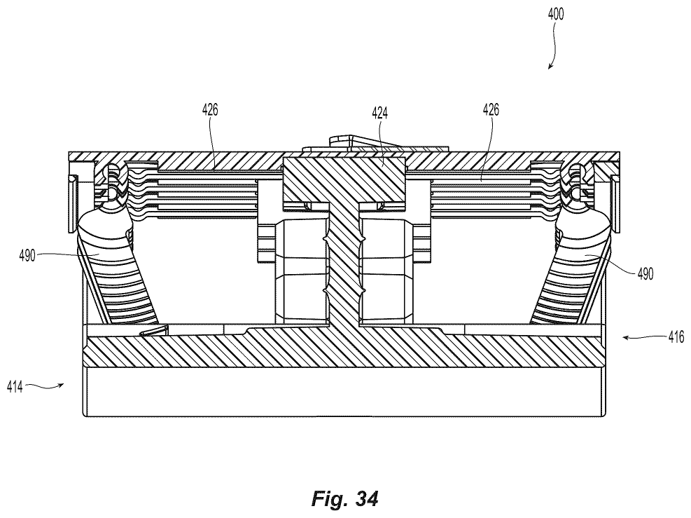

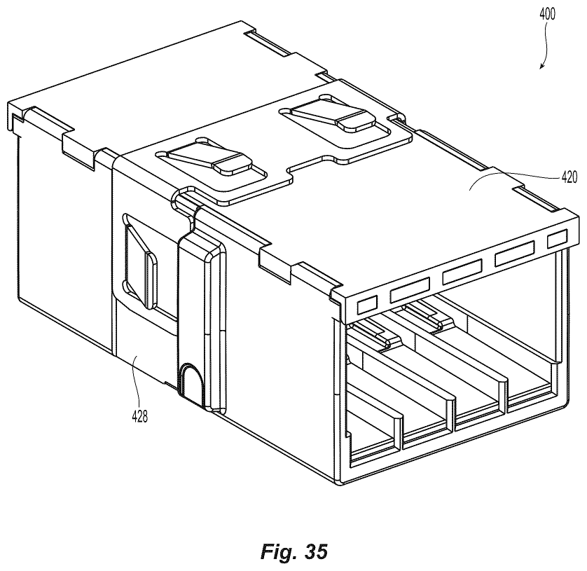

Another embodiment a fiber optic adapter 400 to accommodate at least two very small form factor (VSFF) connectors (VSFF fiber-optic connectors) 300 is illustrated in FIGS. 32 and 34-35. In this case, the fiber optic adapter 400 has shutters 490 and related structures on both a first side 414 and a second side 416 of the main body 402. The shutter spring 422 is formed by a plurality of extensions 426 that extend away from a central beam or portion 424 of the main body 402 and toward both the first side 414 and the second side 416. Rather than the adapter clip 428 keeping the shutter spring 422 in place, there is a shutter support roof 420 that, once secured to the main body 402 at the central beam 424, keeps the shutter spring 422 in place. The remaining elements of the fiber optic adapter 400 are similar to those in the previous embodiment. As illustrated in FIG. 33, there is a fiber optic adapter 400′ that shows the shutter spring 422′ may be made of two similar pieces, allowing for the shutters 409 to be present on both sides 414,416 of the fiber optic adapter 400′.

A fiber optic adapter to accommodate at least two very small form factor (VSFF) fiber-optic connectors is provided. The fiber optic adapter comprises a main body formed by two long sides bound by two opposing short sides and having a main opening along a longitudinal axis between a first side and a second side of the main body; an adapter clip positioned partially about the main body on an outside surface thereof; a shutter spring extending away from the adapter clip toward at least one of the first side and the second side, the shutter spring formed by one or more extensions having a respective free end; a shutter support roof engaged to only one of the two long sides and having one or more grips on an underside thereof; and one or more shutters attached to respective ones of the one or more grips of the shutter support roof, engages to a free end of the one or more extensions of the shutter spring, wherein the one or more shutters are rotatable between a closed position and an open position into the main body to receive one of the at least two VSFF fiber-optic connectors.

In the fiber-optic adapter, each of the plurality of shutters have a first side wall and a second wall, the first side wall having a first plurality of elongated arcuate ribs, the second side wall having a second plurality of elongated arcuate ribs, the first plurality of ribs being offset from the second plurality of ribs along a length of the each of the plurality of shutters, such that the first plurality of elongated arcuate ribs on the first wall of one of the plurality of shutters fit between the second plurality of elongated arcuate ribs on the second wall of an adjacent one of the plurality of shutters.

In the fiber-optic adapter, the first plurality of elongated arcuate ribs and the second plurality of elongated arcuate ribs block light from passing between the two adjacent shutters.

In the fiber-optic adapter, each of the elongated arcuate ribs of each of the plurality of shutters move between the elongated arcuate ribs of an adjacent one of the plurality of shutters.

In the fiber-optic adapter, the first side wall and the second side wall engage a corresponding structure on each side the VSFF fiber-optic connectors to guide the VSFF fiber-optic connectors into and from the fiber optic adapter.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A fiber optic adapter to accommodate at least two very small form factor (VSFF) fiber-optic connectors, the fiber optic adapter comprising:
a main body formed by two long sides bound by two opposing short sides and having a main opening along a longitudinal axis between a first side and a second side of the main body;
a shutter spring extending away from a central portion of the main body, the shutter spring formed by a plurality of extensions;
a shutter support roof having a plurality of grips, the shutter support roof configured to receive the plurality of extensions of the shutter spring; and
a plurality of shutters, each of the plurality of shutters being attached to at least another one of the plurality of shutters and also to the plurality of grips of the shutter support roof, each of the plurality of shutters engaging a respective one of the plurality of extensions of the shutter spring, wherein each of the plurality of shutters is rotatable between a closed position and an open position to receive one of the at least two VSFF fiber-optic connectors.

2. The fiber-optic adapter of claim 1, wherein the shutter spring is integral with an adapter clip, the adapter clip positioned at least partially around the main body.

3. The fiber-optic adapter of claim 1, wherein the plurality of extensions are attached to a central beam, the central beam disposed under the shutter support roof.

4. The fiber-optic adapter of claim 3, wherein the plurality of extensions comprise a first plurality of extensions and a second plurality of extensions, the first plurality of extensions disposed on a first side of the central beam and the second plurality of extensions disposed on a second side, the first plurality of extensions extending away from the central beam and the second plurality of extensions.

5. The fiber-optic adapter of claim 1, herein the shutter support roof has a plurality of windows to receive the plurality of extensions.

6. The fiber-optic adapter of claim 1, wherein the shutter support roof has a plurality of openings, each of the plurality of openings to engage one of a plurality of posts on the main body.

7. The fiber-optic adapter of claim 1, wherein each of the plurality of shutters have a first side wall and a second wall, the first side wall having a first plurality of elongated arcuate ribs, the second side wall having a second plurality of elongated arcuate ribs, the first plurality of ribs being offset from the second plurality of ribs along a length of the each of the plurality of shutters, such that the first plurality of elongated arcuate ribs on the first wall of one of the plurality of shutters fit between the second plurality of elongated arcuate ribs on the second wall of an adjacent one of the plurality of shutters.

8. The fiber-optic adapter of claim 7, wherein the first plurality of elongated arcuate ribs and the second plurality of elongated arcuate ribs block light from passing between the two adjacent shutters.

9. The fiber-optic adapter of claim 7, wherein the elongated arcuate ribs of each of the plurality of shutters move between the elongated arcuate ribs of an adjacent one of the plurality of shutters.

10. The fiber-optic adapter of claim 1, wherein the first side and the second side are separated by a central wall at which the at least two VSFF fiber-optic connectors mate with each other.

11. The fiber-optic adapter of claim 1, wherein the fiber-optic adapter is a single port or a multi-port adapter.

12. The fiber-optic adapter of claim 7, wherein the first side wall and the second side wall engage a corresponding structure on each side the VSFF fiber-optic connectors to guide the VSFF fiber-optic connectors into and from the fiber optic adapter.

13. The fiber-optic adapter of claim 12, wherein the corresponding structure that engages the first side wall and the second side wall is a rail on each side of a housing of the at least two VSFF fiber-optic connectors.

14. The fiber-optic adapter of claim 7, wherein the first side wall and the second side wall are outward facing.

15. (canceled)

16. A fiber optic adapter to accommodate at least two fiber-optic connectors, the fiber optic adapter comprising:
a main body formed by a top and a bottom bound by two opposing sides and having a main opening along a longitudinal axis between a first side and a second side of the main body, wherein the main body include at least two ports to respectively receive the at least two fiber-optic connectors;
a shutter spring having an extension positioned away from a central portion of the main body;
a shutter support roof having a plurality of grips, the shutter support roof configured to engage the extension of the shutter spring; and
a plurality of shutters, each of the plurality of shutters being aligned with at least another one of the plurality of shutters and attached to the plurality of grips of the shutter support roof, each of the plurality of shutters engaging the shutter spring, wherein each of the plurality of shutters is rotatable between a closed position and an open position to receive one of the at least two fiber-optic connectors.

17. The fiber optic adapter of claim 16, wherein each of the plurality of shutters is rotatably attached to respective ones of the plurality of grips.

18. The fiber optic adapter of claim 16, wherein each of the plurality of shutters includes a plurality of elongated arcuate ribs of an outside surface of each side wall of each of the plurality of shutters.

19. The fiber optic adapter of claim 18, wherein the plurality of elongated arcuate ribs on said each side wall fit between another plurality of elongated arcuate ribs on a side wall of an adjacent shutter in the adapter.

20. A fiber optic adapter to accommodate at least two fiber-optic connectors, the fiber optic adapter comprising:
a main body formed by a top and a bottom bound by two opposing sides and having a main opening along a longitudinal axis between a first side and a second side of the main body, wherein the main body include at least one port to respectively receive the at least two fiber-optic connectors from opposite sides of the main opening;
a shutter spring having an extension positioned away from a central portion of the main body;
a shutter support roof having a plurality of grips, the shutter support roof configured to engage the extension of the shutter spring; and
a plurality of shutters, each of the plurality of shutters being associated with the at least one port on the opposite sides of the main opening and respectively attached to the plurality of grips of the shutter support roof, each of the plurality of shutters engaging the shutter spring, wherein each of the plurality of shutters is rotatable between a closed position and an open position to receive one of the at least two fiber-optic connectors.
